(19) United States
(12) Patent Application Publication
(10) Pub. No.: US 2013/0268554 A1
(43) Pub. Date: Oct. 10, 2013

(54) STRUCTURED DOCUMENT MANAGEMENT APPARATUS AND STRUCTURED DOCUMENT SEARCH METHOD

(71) Applicants: KABUSHIKI KAISHA TOSHIBA, Tokyo (JP); TOSHIBA SOLUTIONS CORPORATION, Tokyo (JP)

(72) Inventors: Tomohiro Kokubu, Kanagawa (JP); Toshihiko Manabe, Kanagawa (JP); Wataru Nakano, Kanagawa (JP)

(73) Assignees: TOSHIBA SOLUTIONS CORPORATION, Tokyo (JP); KABUSHIKI KAISHA TOSHIBA, Tokyo (JP)

(21) Appl. No.: 13/845,878

(22) Filed: Mar. 18, 2013

Related U.S. Application Data
(63) Continuation of application No. PCT/JP2012/068505, filed on Jul. 20, 2012.

(30) Foreign Application Priority Data
Mar. 14, 2012 (JP) 2012-057240

(51) Int. Cl. G06F 17/30

(52) U.S. Cl. CPC G06F 17/30477
USPC 707/769

(57) ABSTRACT

According to an embodiment, a structured document management apparatus includes a document storage unit, a section title extracting unit, a relevance calculator, a document search unit, a section title selector, and a section title display controller. The section title extracting unit extracts the section titles from the structured document to create a section title list. The relevance calculator calculates degrees of conceptual relevance between the section title and words included in the section text corresponding to the section title for each of the section texts. The document search unit searches for the section text that includes the word identical to a search keyword. The section title selector selects the section title having a higher degree of relevance with the word identical to the search keyword more preferentially than the section title having a lower degree of relevance with the word identical to the search keyword.

### CROSS-REFERENCE TO RELATED APPLICATIONS

This application is a continuation of PCT international application Ser. No. PCT/JP2012/068505 filed on Jul. 20, 2012 which designates the United States, incorporated herein by reference, and which claims the benefit of priority from Japanese Patent Application No. 2012-057240, filed on Mar. 14, 2012, the entire contents of which are incorporated herein by reference.

### FIELD

Embodiments described herein relate generally to a structured document management apparatus and a structured document search method.

### BACKGROUND

In the related art, a technique of generating electronic data as a structured document to make it easy to share information and efficiently search information is known. For example, the hyper text markup language (HTML) can express the structure of a document by describing constituent elements of the document, for example, a section title, the body text, or a list structure of a document, using tags. Moreover, the extensible markup language (XML) that can uniquely define tags that express a document structure depending on a purpose is also used. When data is searched for from such a structured document, tags make it easy to identify which data is located at which position in the document. Thus, search performance can be improved.

As a method of displaying the search results on such a structured document, a document summarization technique of automatically generating a summary from sentences in the search results and displaying the summary is known. A keyword-in-context (KWIC) is known as a typical document summarization technique, and according to the KWIC technique, a predetermined number of characters before and after the text that includes a search keyword are extracted from a search target document and are displayed.

Moreover, as another method of displaying the search results on the structured document, a method of displaying section titles corresponding to a document that includes a word identical to a keyword used for search as search results is known.

However, in the case of displaying section titles as the search results, even if a search keyword is identical to a word in the document, when the section titles have a low degree of relevance to the search keyword, the user may not recognize that the information is what the user tries to find. In this case, the user needs to personally read the sentence to check whether the information is relevant to the content that the user wants to find. Thus, there is a need to further improve search convenience.

### BRIEF DESCRIPTION OF THE DRAWINGS

FIG. 1 is a schematic view illustrating a system establishment example of a structured document management system;

FIG. 2 is a module configuration diagram of a server and a client terminal;

FIG. 3 is a block diagram illustrating a general configuration of a server and a client terminal according to a first embodiment;

FIG. 4 is a diagram illustrating an example of a structured document according to the first embodiment;

FIG. 5 is a diagram illustrating an example of a structured document according to the first embodiment;

FIG. 6 is a diagram illustrating an example of a section title list according to the first embodiment;

FIG. 7 is a diagram illustrating an example of a concept dictionary according to the first embodiment;

FIG. 8 is a data diagram illustrating the degrees of relevance between words according to the first embodiment;

FIG. 9 is a diagram illustrating a degree of relevance between a section title and words in the body text according to the first embodiment;

FIG. 10 is a diagram illustrating an example of a method of displaying search results according to the first embodiment;

FIG. 11 is a diagram illustrating a modification of a method of displaying search results according to the first embodiment;

FIG. 12 is a flowchart illustrating the flow of the process of registering a structured document according to the first embodiment;

FIG. 13 is a flowchart illustrating the flow of the process of calculating the degrees of relevance between section titles and words in the body text according to the first embodiment;

FIG. 14 is a flowchart illustrating the flow of the process of determining section titles as search results during search according to the first embodiment; and

FIG. 15 is a flowchart illustrating the flow of the process of determining section titles as search results during search according to a second embodiment.

### DETAILED DESCRIPTION

According to an embodiment, a structured document management apparatus includes a document storage unit, a section title extracting unit, a relevance calculator, a document search unit, a section title selector, and a section title display controller. The document storage unit is configured to store a structured document that includes a plurality of section texts each including a section title and a body text. The section title extracting unit is configured to extract the section titles from the structured document to create a section title list. The relevance calculator is configured to calculate degrees of conceptual relevance between the section title and words included in the section text corresponding to the section title for each of the section texts. The document search unit is configured to search for the section text that includes the word identical to a search keyword. The section title selector is configured to select the section title having a higher degree of relevance with the word identical to the search keyword more preferentially than the section title having a lower degree of relevance with the word identical to the search keyword. The section title display controller is configured to display the selected section title on a display unit as a presentation section title.

### First Embodiment

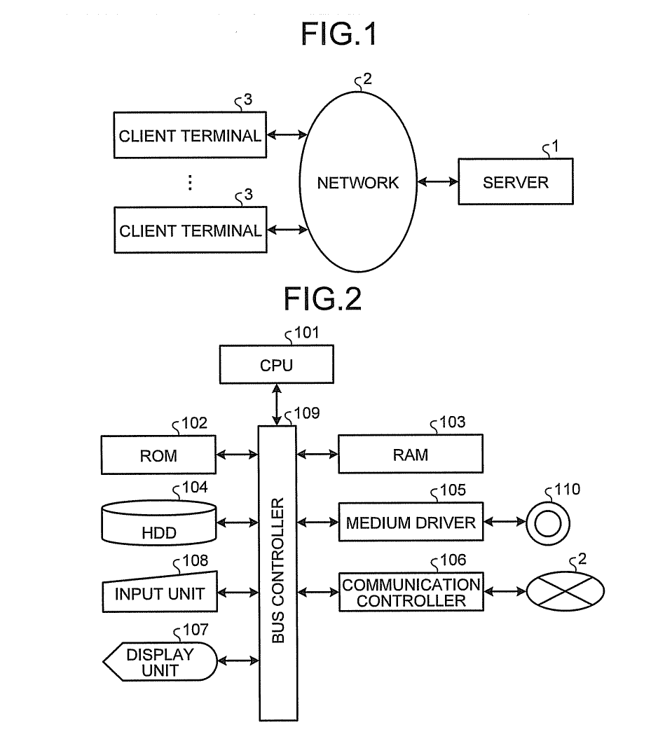

Hereinafter, a first embodiment of a structured document management apparatus will be described in detail with reference to the drawings. FIG. 1 is a schematic view illustrating a system establishment example of the structured document management system according to the first embodiment. It will be assumed that the structured document management system according to this embodiment is a server-client system in which as illustrated in FIG. 1, a plurality of client computers (hereinafter, referred to as client terminals) 3 is connected to a server computer (hereinafter, referred to as a server) 1 which is a structured document management apparatus via a network 2 such as a local area network (LAN).

FIG. 2 is a module configuration diagram of the server 1 and the client terminal 3. The server 1 and the client terminal 3 have a hardware configuration which uses a general computer, for example. Specifically, the server 1 and the client terminal 3 include a central processing unit (CPU) 101 that processes information, a read only memory (ROM) 102 which is read only memory that stores a BIOS and the like, a random access memory (RAM) 103 that stores various items of data in a rewritable manner, a hard disc drive (HDD) 104 that functions as various databases and stores various programs, a medium driver 105 such as a CD-ROM drive for storing information, distributing information to the outside, and obtaining information from the outside using a storage medium 110, a communication controller 106 used for transferring information to another external computer via the network 2 by communication, a display unit 107 such as a cathode ray tube (CRT) or a liquid crystal display (LCD) that displays the progress, results, and the like of processing to an operator, an input unit 108 such as a keyboard and a mouse, which allows the operator to input instructions, information, and the like to the CPU 101, and the like. A bus controller 109 controls the data transmitted and received between these respective components to operate the server 1 and the client terminal 3.

When the user powers on the server 1 and the client terminal 3, the CPU 101 activates a program called a loader in the ROM 102 to read a program called an operating system (OS), which manages hardware and software of a computer, from the HDD 104 into the RAM 103, and to activate the OS. Such an OS activates a program and reads and stores information according to an operation of the user. As a typical OS, Windows (registered trademark), UNIX (registered trademark), and the like are known. Programs running on such an OS are called application programs. Application programs are not limited to those running on a predetermined OS, and may be those which cause the OS to take over execution of part of various types of processing described later and those which are included as part of a group of program files that constitutes predetermined application software, an OS, or the like.

Here, the server 1 stores a structured document management program in the HDD 104 as an application program. In this sense, the HDD 104 functions as a storage medium that stores the structured document management program. Moreover, in general, an application program installed in the HDD 104 of the server 1 is provided in a state of being recorded on the storage medium 110 such as media of various schemes, for example, various types of optical disks such as a CD-ROM and a DVD, various types of magneto-optical disks, various types of magnetic disks such as a flexible disk, and semiconductor memories. Thus, the portable storage medium 110 such as an optical information storage medium (for example, a CD-ROM) or a magnetic medium (for example, an FD) can be a storage medium that stores the structured document management program. Further, the structured document management program may be imported from the outside via the communication controller 106 and installed in the HDD 104.

In the server 1, when the structured document management program running on the OS is activated, the CPU 101 intensively controls the respective components by executing various types of arithmetic processing according to the structured document management program. On the other hand, in the client terminal 3, when an application program running on the OS is activated, the CPU 101 intensively controls the respective components by executing various types of arithmetic processing according to the application program. Among various types of arithmetic processing executed by the CPU 101 of the server 1 and the client terminal 3, characteristic processing of the structured document management system according to the embodiment will be described below.

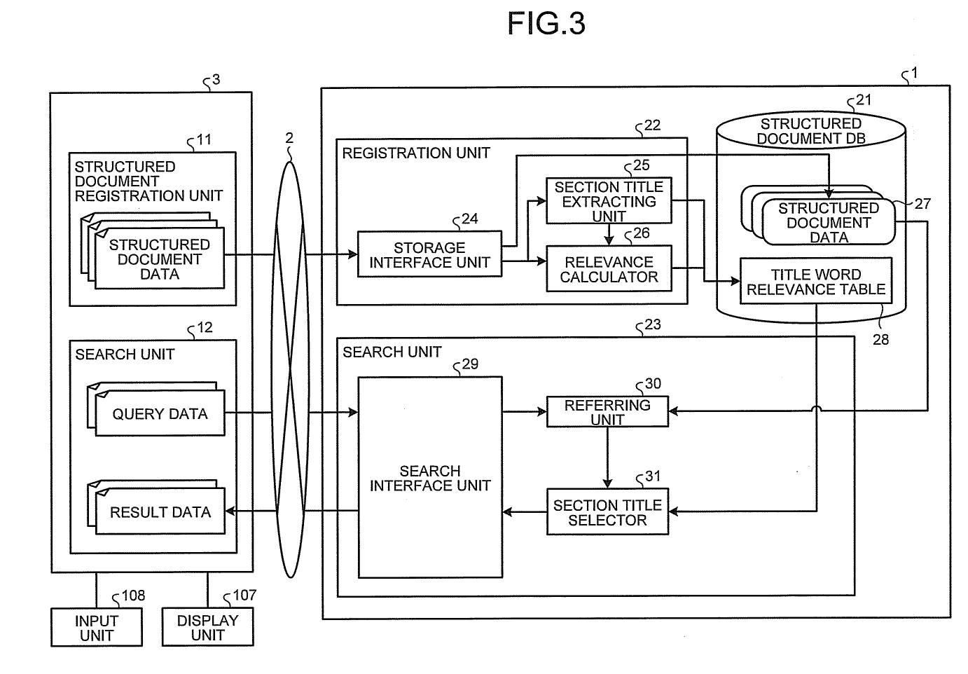

FIG. 3 is a block diagram illustrating a general configuration of the server 1 and the client terminal 3 according to the first embodiment. As illustrated in FIG. 3, the client terminal 3 includes a structured document registration unit 11 and a search unit 12 as functional configurations that are realized by the application program.

The structured document registration unit 11 registers structured document data input from the input unit 108 and structured document data stored in advance in the HDD 104 of the client terminal 3 in a structured document database (structured document DB) 21 of the server 1, which will be described later. The structured document registration unit 11 sends a storage request to the server 1 together with the structured document data to be registered.

The search unit 12 creates query data that describes search keywords or the like for searching the structured document DB 21 for desired data according to an instruction of the user input from the input unit 108 and sends a search request including the query data to the server 1. Moreover, the search unit 12 receives result data corresponding to the search request sent from the server 1 and displays the result data on the display unit 107.

On the other hand, the server 1 includes a registration unit 22 and a search unit 23 as functional configurations that are realized by the structured document management program. Moreover, the server 1 includes the structured document DB 21 which uses a storage device such as the HDD 104.

The registration unit 22 performs a process of receiving a storage request from the client terminal 3 and storing the structured document data sent from the client terminal 3 in the structured document DB 21. The registration unit 22 includes a storage interface unit 24, a section title extracting unit 25, and a relevance calculator 26.

The storage interface unit 24 receives the input of the structured document data and parses the structured document data sent from the client terminal 3 in order to store the structured document data in the structured document DB 21. Moreover, the storage interface unit 24 assigns an identifier (hereinafter, referred to as an element ID) to elements that appear in data so that the orders of appearance of the elements can be compared, and then, stores the structured document data to which the element ID is assigned in the structured document DB 21 (a structured document data storage unit). The element ID may be manually assigned in advance to the structured document on the client terminal 3 side.

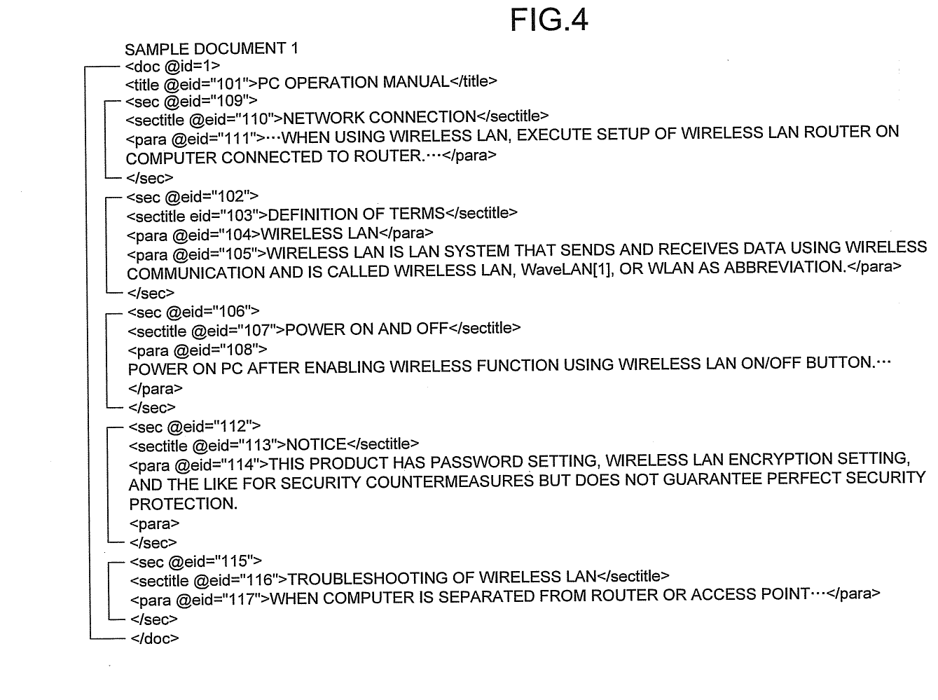

FIG. 4 illustrates an example of structured document data to which the element ID is assigned. Extensible Markup Language (XML) is a typical language for describing the structured document data. The structured document data illustrated in FIG. 4 is described in XML. In XML, individual parts that constitute a document structure are referred to as “elements”, and the elements are described using tags. Specifically, one element is expressed in such a way that data is surrounded by two tags which include a tag (start-tag) that indicates the start of an element and a tag (end-tag) that indicates the end of the element. Text data surrounded by the start-tag and the end-tag is a text element included in one element that is represented by the start-tag and the end-tag.

In FIG. 4, a root element called that is surrounded by <doc> tags is present. A <doc> element is assigned with “id=1” as a document ID of the document. The <doc> element has a <title> element, and the <title> element represents a section title of the structured document. Moreover, the <doc> element has five <sec> elements. The <sec> element is a structured document that has a parent-child relationship with a structured document that is defined by the <doc> element, and in this embodiment, the <sec> element is referred to as a section text. A <sectitle> element and a <para> element are included in a portion that is surrounded by <sec> tags. The <sectitle> is a tag that indicates a section title of the section text. Moreover, the <para> is a tag that indicates descriptive text of the section text. The text defined by the <sectitle> and <para> tags corresponds to “body”. An element ID is assigned to each tag in a format of @eid.

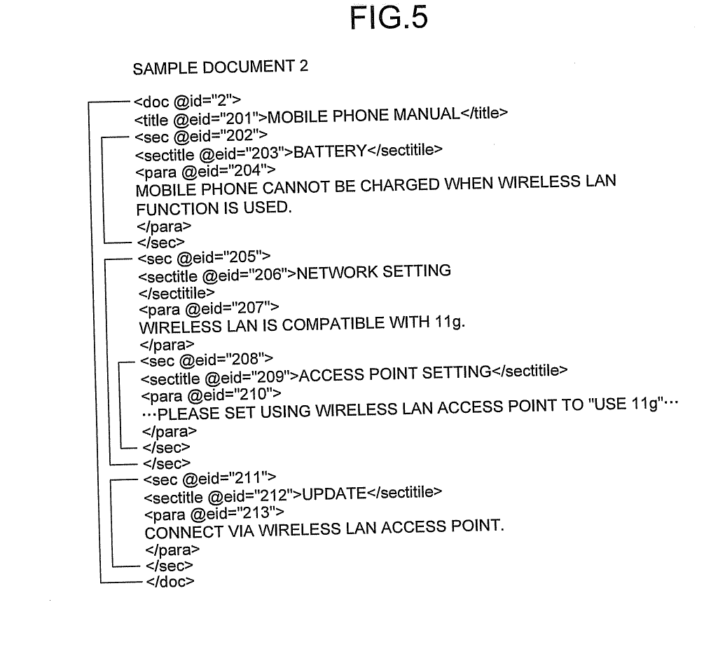

Similarly, FIG. 5 illustrates an example of the structured document. The structured document illustrated in FIG. 5 has the same structure as the structured document of FIG. 4. However, a section text defined at @eid=208 which is an element ID is included in a section text that is defined at @eid=205, and the two section texts form such a layered structure that has a parent-child relationship.

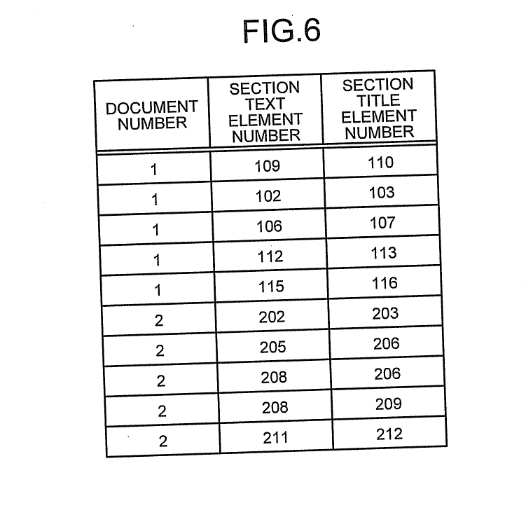

The section title extracting unit 25 extracts section titles from the structured document accepted from the storage interface unit 24 and lists the extracted section titles. When section titles are extracted, the text surrounded by the <sectitle> elements within a structured document is recognized as section titles. FIG. 6 illustrates an example of data that lists section titles of two structured documents corresponding to document IDs 1 and 2. As illustrated in FIG. 6, in the structured document corresponding to the document ID 1, @eid=110, 103, 107, 113, and 116 are respectively extracted for section texts indicated by the element IDs 109, 102, 106, 112, and 115 as section titles.

Moreover, in the structured document corresponding to the document ID 2, @eid=203, 206, and 212 are respectively extracted for section texts indicated by the element IDs 202, 205, and 211 as section titles. Further, two section titles of @eid=206 and 209 are extracted for a section text indicated by the element ID 208. In the structured document corresponding to the document ID 2, not only the section title of @eid=209 surrounded by the <sec> tags of its own, but also the section title of @eid=206 on the parent layer is also extracted as the section titles of the section text indicated by the element ID 208. In this embodiment, a child text is a section text defined by the <sec> element on the child layer within the <sec> element that defines a section text on the parent layer. In the structured document illustrated in FIG. 5, the section text @eid=208 corresponds to a child text for the section text @eid=205 that includes the section title @eid=206, and the section text @eid=205 corresponds to a parent section text for the section text @eid=208.

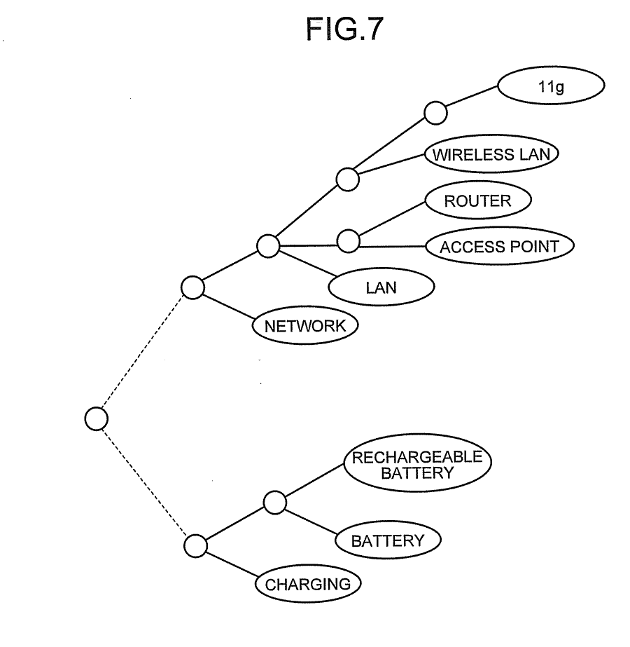

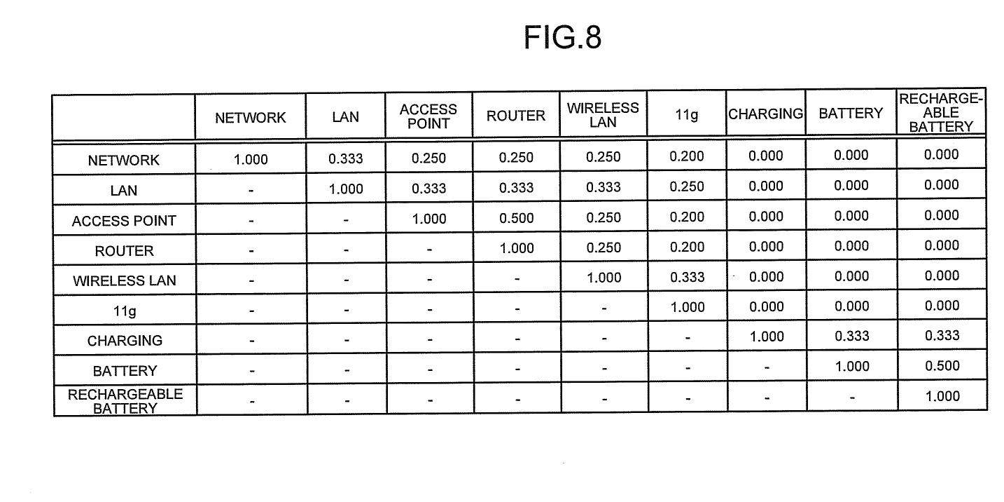

The section title extracting unit 25 stores the generated section title list in the structured document DB 21 and delivers the section title list to the relevance calculator 26. The relevance calculator 26 calculates the degrees of relevance between the section titles extracted by the section title extracting unit 25 and the words included in the corresponding section text. A concept dictionary illustrated in FIG. 7 is used in calculation of the degrees of relevance. The concept dictionary illustrates the degree of similarity between respective concepts based on a hierarchical structure of concepts. For example, “router” and “access point” in FIG. 7 are located on the same layer that braches from the same node, and a conceptual length is depicted as “1”. Moreover, a conceptual length L between a parent node and a child node is depicted as “1”. FIG. 8 is a table in which the degrees of relevance between words are calculated based on dictionary relevance that is set in advance in the concept dictionary. The degree of relevance is expressed using the conceptual length L and calculated by 1/(L+1), and is depicted as “0” when the length L is 5 or more.

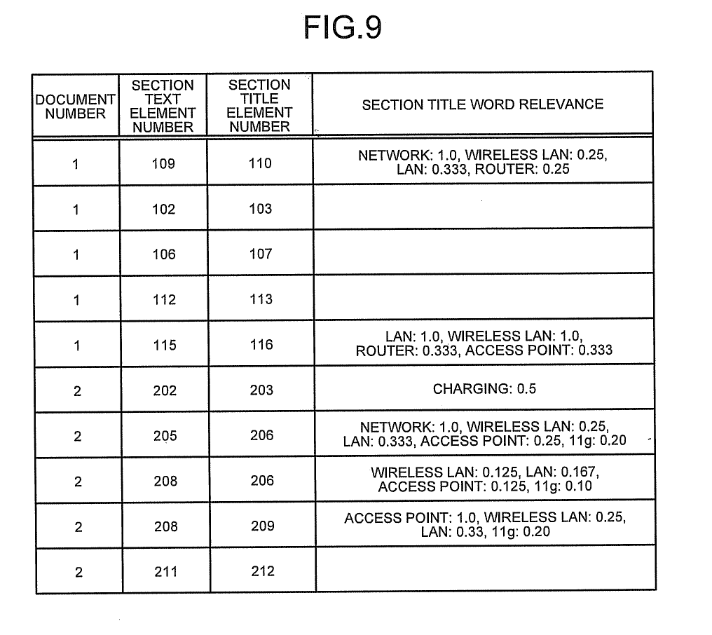

The relevance calculator 26 extracts words from respective section titles and calculates the degrees of relevance between the extracted words and the words in the body text. An existing word extracting method can be used; and words in a concept dictionary are recognized and extracted from the text herein. For example, two words “LAN” and “wireless LAN” are extracted as words from the section title “troubleshooting of wireless LAN” defined at @eid=116. On the other hand, words “LAN”, “wireless LAN”, “router”, and “access point” are extracted from the body text defined at @eid=115 of the section text. In this case, the degrees of relevance between the respective words and each of the words in the section title are calculated. The degrees of relevance between the words “LAN”, “wireless LAN”, “router”, and “access point” and the word “LAN” are “1.0”, “0.333”, “0.333” and “0.333”, respectively, and the degrees of relevance between the words “LAN”, “wireless LAN”, “router”, and “access point” and the word “wireless LAN” are “0.333”, “1.0”, “0.25”, and “0.25”, respectively. In this case, since the higher degrees of relevance for the respective words are used preferentially, the degrees of relevance between the words in the section text corresponding to @eid=115 and the words in the section text corresponding to @eid=116 are “1.0”, “1.0”, “0.333”, and “0.333”. The relevance calculator 26 performs this calculation with respect to each combination of section titles and section texts and stores the calculation results in the structured document DB 21 as a title word relevance table 28 illustrated in FIG. 9. In calculation of the degrees of relevance, for example, as in the case of the section title @eid=206 of the document ID 2, the degree of relevance with the section text on the child layer is calculated to be lower than the degree of relevance with the section text on the same layer, and in this embodiment, is calculated to a value that is ½ of 1/(L+1). In this manner, the deeper the layer of the structured document, the lower the degree of relevance.

Returning to FIG. 3, a functional configuration of the search unit 23 will be described. The search unit 23 includes a search interface unit 29, a referring unit 30, and a section title selector 31.

The search interface unit 29 receives the input of a search keyword and calls the referring unit 30 in order to obtain data that includes a word that is identical to a search keyword designated by query data that includes the received search keyword.

The referring unit 30 accesses the structured document DB 21 to search structured documents that include the search keyword designated by the query data from structured document data 27 and sends a list of section texts that include a word identical to the search keyword to the section title selector 31. For example, when the search keyword is “wireless LAN”, @eid=109, 102, 106, 112, and 115 of the document ID 1 and @eid=202, 205, 208, and 211 of the document ID 2 are hit as the section texts, and the search results are sent to the section title selector 31.

The section title selector 31 selects section titles which have the higher degrees of relevance with the word that is identical to the search keyword more preferentially than section titles which have the lower degrees of relevance and delivers the selection results to the search interface unit 29. As a method of preferentially selecting section titles which have the higher degrees of relevance, a method of not selecting section titles which have small degrees of relevance and selecting only section titles of which the degrees of relevance are on the higher rank may be used. Specifically, first, the section title selector 31 examines, from the title word relevance table 28, the degrees of relevance between the section titles of the respective hit section texts and the word that is identical to the search keyword. As for the search keyword “wireless LAN”, section titles of which the degrees of relevance are higher than “0” are @eid=110 and 116 for the document ID 1, and the section title selector 31 acquires these degrees of relevance. The section title selector 31 selects the top N (for example, two) of the acquired degrees of relevance to determine section titles that are to be displayed in the search results as display section titles. In this case, the section title @eid=110 corresponding to the element ID @eid=109 of the section text of the document ID 1 and the section title @eid=116 corresponding to the element ID @eid=115 of the section text are selected. Moreover, the section title @eid=206 corresponding to the element ID @eid=205 of the section text of the document ID 2 and the section title @eid=209 corresponding to the element ID @eid=208 of the section text are selected. The section title selector 31 sends the selection results to the search interface unit 29.

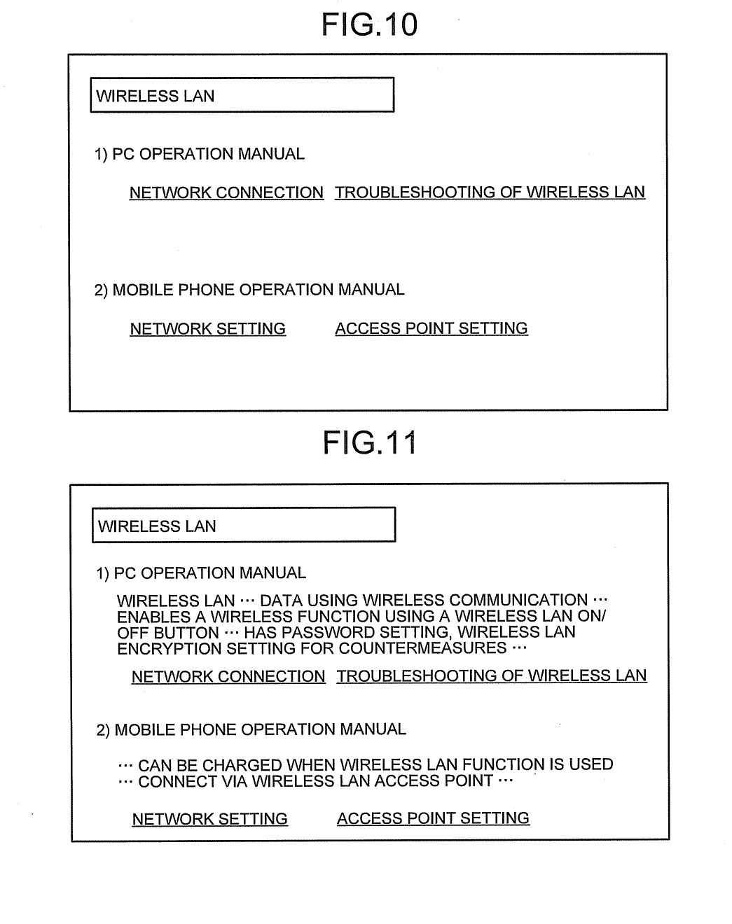

The search interface unit 29 outputs the section titles received from the section title selector 31 to the display unit 107 so that the section titles are displayed. FIG. 10 illustrates an example of a search result screen displayed on a display unit. As illustrated in FIG. 10, the search interface unit 29 performs processing such that two display section titles “Network Connection” and “Troubleshooting of Wireless LAN” are displayed under “PC Operation Manual” which is the title of the document ID 1. Moreover, the search interface unit 29 displays “Network Setting” and “Access Point Setting” which are display section titles under “Mobile Terminal Operation Manual” which is the title of the document ID 2. The user can view the body text associated with the presentation section title by selecting the displayed presentation section title.

As another example of the display screen, a display screen illustrated in FIG. 11 may be used. In FIG. 11, as for section titles other than the section titles sent from the section title selector 31, the search interface unit 29 also displays texts that appear before and after each word that is identical to the search keyword. As illustrated in FIG. 11, “wireless LAN . . . data using wireless communication” which is the body text within the section text of @eid=102, “enables a wireless function using a wireless LAN ON/OFF button . . . ” which is the body text within the section text of @eid=106, and “has password setting, wireless LAN encryption setting for countermeasures . . . ” which is the body text within the section text of @eid=112 are displayed under “PC Operation Manual” which is the document title. The number of characters that appears before and after each word that is identical to the search keyword to be extracted can be changed appropriately. By doing so, since the degree of relevance between the word in the section title and the word identical to the search keyword is low, even when it is difficult for the user to understand whether the search keyword is included in the section texts of a document from the presentation section title, the user can easily understand the content of the document from the sentences. In this embodiment, the search interface unit 29 corresponds to a section title display controller and a body text display controller.

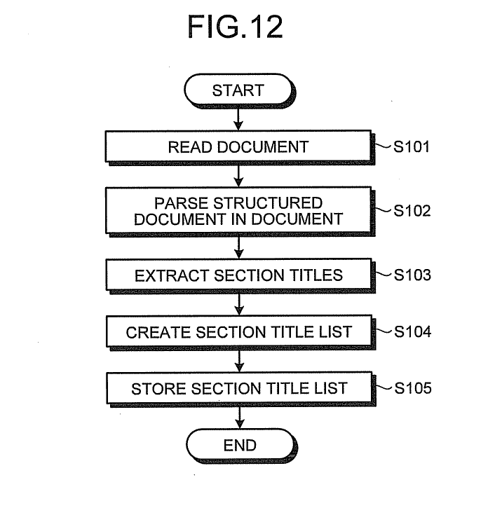

The flow of processes of registering and searching structured documents according to this embodiment will be described with reference to FIGS. 12 to 14. FIG. 12 illustrates the flow of the process of registering structured documents. The process of FIG. 12 starts when an instruction to register a structured document is issued from the structured document registration unit 11 of the client terminal 3, for example. First, the storage interface unit 24 reads the structured document sent from the client terminal 3 (step S101). The section text in the document is then identified (step S102). Subsequently, the section title extracting unit 25 extracts section titles from the identified section text (step S103). Moreover, the section title extracting unit 25 creates a section title list from the extracted section titles (step S104) and stores the section title list in the structured document DB 21 (step S105). After that, the process ends.

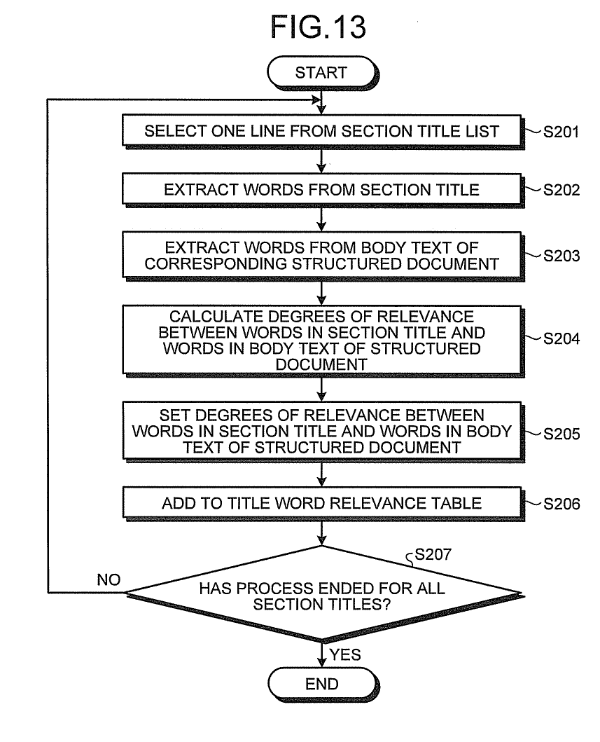

Next, the flow of the process of calculating the degree of relevance between section titles and words in the body text will be described with reference to FIG. 13. As illustrated in FIG. 13, the relevance calculator 26 selects a section title corresponding to one line of data from the section title list stored in the structured document DB 21 (step S201). Subsequently, the relevance calculator 26 extracts words from the selected section title (step S202). After that, the relevance calculator 26 extracts words from the section title and the corresponding body text in this example, the text defined by <sectitle> and <para> tags (step S203). The relevance calculator 26 calculates the degrees of relevance between the words in the section title and the words in the section text (step S204). When there are a number of words in the section title, the relevance calculator 26 sets the higher one of the degrees of relevance with the respective words as the degree of relevance of the section title (step S205). Moreover, the relevance calculator 26 adds relevance data to the item of “section title-word relevance” of the corresponding data of combinations of section texts and section titles of the title word relevance table 28 (step S206). Finally, it is determined whether the process of calculating the degrees of relevance for all section titles has been completed (step S207). When the process has been completed (Yes in step S207), a series of processes end. When the process has not been completed (No in step S207), the same process is repeated for the section title on the next line.

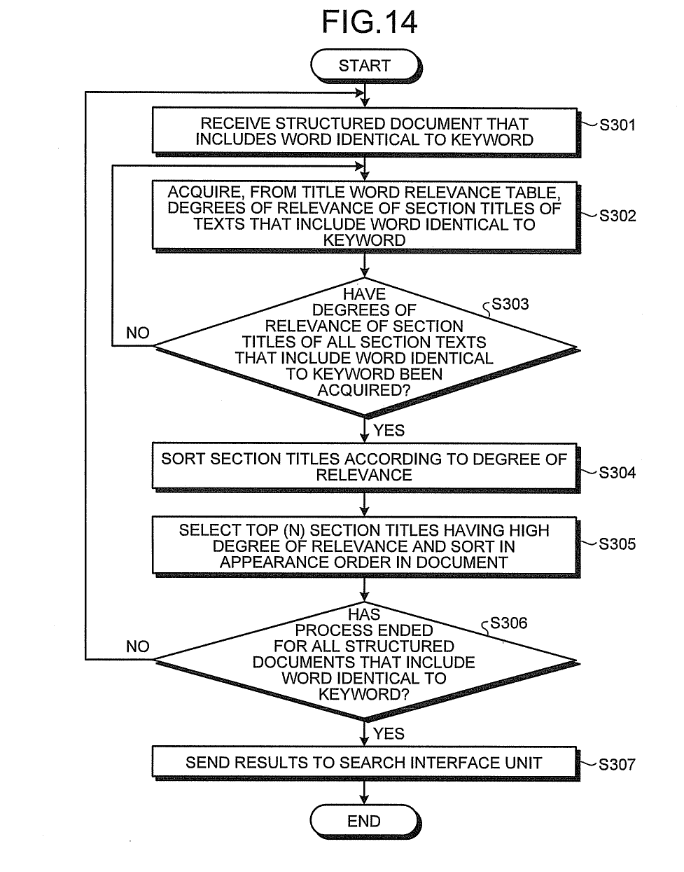

Next, the flow of the process in which the section title selector 31 selects section titles during search will be described with reference to FIG. 14. The section title selector 31 acquires a structured document that includes a word identical to the search keyword (step S301). Subsequently, the section title selector 31 acquires, from the title word relevance table 28, the degrees of relevance of the section titles of the section texts that include the word identical to the search keyword within the structured document (step S302). The section title selector 31 determines whether the degrees of relevance for all section texts that include identical words (step S303). When the degrees of relevance for all section texts have been acquired (Yes in step S303), the section title selector 31 sorts the section titles of the section texts that include identical words in descending order of the degrees of relevance (step S304). On the other hand, when it is determined that the degrees of relevance for all section texts have not been acquired (No in step S303), the process of step S302 is repeated. The section title selector 31 selects the top N section titles having the higher degrees of relevance and sorts the section titles in their appearance order in the structured document (step S305). Moreover, the section title selector 31 determines whether section titles of all structured documents (in this embodiment, two documents having the document IDs 1 and 2) have been selected (step S306). When the section titles of all structured documents have been selected (Yes in step S306), the section title selector 31 sends the section titles selected and sorted in step S305 to the search interface unit 29 as presentation section titles (step S307) and ends the process. When the section titles of all structured documents have not been selected (No in step S306), the processes starting with step S301 are repeated, and another structured document is acquired.

In the structured document management apparatus according to this embodiment, when a section text that includes a word that is identical to the keyword used for search is present, section titles having a high degree of relevance with the search keyword are displayed preferentially. Thus, the user can easily determine whether the information that the user wants to find is included in the document from the presentation section title. When the presentation section title is used, the user does not need to personally read the sentences to determine whether the sentences are close to the content that the user wants to find and thus can immediately understand the location in the structured document at which the information that the user wants to find is located.

The section title selector 31 may select section title having a predetermined degree of relevance or higher rather than selecting the top N section titles having the higher degrees of relevance. Moreover, the section title selector 31 may select the top N section titles which have a predetermined degree of relevance or higher.

Further, the configuration in which when displaying presentation section titles on the display unit, the section titles are sorted in the order in which the section titles are displayed within the structured document, or the top section titles are displayed first is not essential.

Furthermore, the type of tags that defines section titles and the body text is not limited to that of this embodiment but can be freely set.

### Second Embodiment

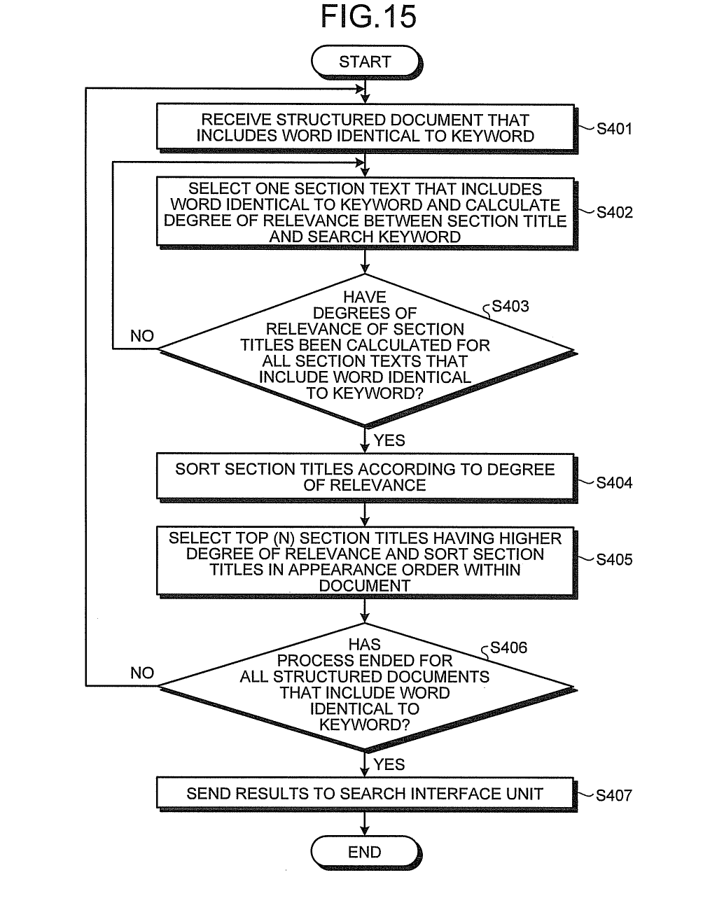

Next, a second embodiment of a structured document management apparatus will be described with reference to FIG. 15. The second embodiment is different in that the degrees of relevance of only the section texts that each include a word identical to the keyword used when the user performs search are calculated rather than calculating the degrees of relevance between section titles of a section text and the words in the body text in advance at the time of registering a structured document and registering the degrees of relevance.

FIG. 15 is a flowchart illustrating the flow of the process of selecting section titles during search. As illustrated in FIG. 15, the section title selector 31 acquires structured documents that each include the word that is identical to a search keyword (step S401). Subsequently, the relevance calculator 26 selects one section text that includes the word identical to the search keyword among the acquired structured documents and calculates the degrees of relevance between the corresponding section titles and the search keyword (step S402). In this case, the calculation method is the same as the method of calculating the degrees of relevance between section titles and words in the body text according to the first embodiment.

The section title selector 31 determines whether the degrees of relevance have been calculated for the section titles of all section texts that each include the word identical to the search keyword (step S403). When the degrees of relevance for all section texts have been calculated (Yes in step S403), the section title selector 31 sorts the section titles of the section texts that each include the word identical to the search keyword in descending order of the degrees of relevance (step S404). On the other hand, when it is determined that the degrees of relevance for all section texts that each include the word identical to the search keyword have not been calculated (No in step S403), the process of step S402 is repeated. The section title selector 31 selects the top N section titles having the higher degrees of relevance and sorts the section titles in the appearance order in which the section titles appear in the structured document (step S405). Moreover, the section title selector 31 determines whether the section titles of all structured documents (in this embodiment, two documents having the document IDs 1 and 2) have been selected (step S406). When the section titles of all structured documents have been selected (Yes in step S406), the section title selector 31 sends the section titles selected and sorted in step S305 to the search interface unit 29 as presentation section titles (step S407) and ends the process. When the section titles of all structured documents have not been selected (No in step S406), the processes starting with step S401 are repeated.

In this embodiment, since it is not necessary to calculate the degrees of relevance between section titles and words in the body text in advance, the structured document management apparatus may be used even when it is not possible to secure a storage capacity for storing calculation results. Moreover, since it is only necessary to calculate the degrees of relevance between a search keyword and section titles in a section text that includes a word identical to the search keyword, it is possible to suppress the time required for calculation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A structured document management apparatus comprising:
a document storage unit configured to store a structured document that includes a plurality of section texts each including a section title and a body text;
a section title extracting unit configured to extract the section titles from the structured document to create a section title list;
a relevance calculator configured to calculate degrees of conceptual relevance between the section title and words included in the section text corresponding to the section title for each of the section texts;
a document search unit configured to search for the section text that includes the word identical to a search keyword;
a section title selector configured to select the section title having a higher degree of relevance with the word identical to the search keyword more preferentially than the section title having a lower degree of relevance with the word identical to the search keyword; and
a section title display controller configured to display the selected section title on a display unit as a presentation section title.

2. The apparatus according to claim 1, wherein the section title selector selects top N section titles with the highest degrees of relevance, where N is an integer of 1 or more.

3. The apparatus according to claim 1, wherein the section title selector selects the section title of which the degree of relevance has a predetermined value or more.

4. The apparatus according to claim 1, wherein
the section text includes another section text as a child text, and
the relevance calculator calculates the degrees of relevance between the words included in the child text and the section title that is a parent text of the child text so as to be lower than the degree of relevance between the words included in the child text and a section title of the child text.

5. The apparatus according to claim 1, further comprising a body text display controller configured to display, on the display unit, the word identical to the search keyword together with texts appearing before and after the word identical to the search keyword, the texts being included in the section text that includes the word identical to the search keyword and includes a section title not selected by the section title selector.

6. The apparatus according to claim 1, wherein the relevance calculator calculates the degrees of relevance between the section titles and the words in the structured document from a dictionary relevance between words in a concept dictionary that is recorded in advance.

7. The apparatus according to claim 1, wherein
when the displayed section title is selected, the section title display controller displays the body text of the selected section title on the display unit.

8. The apparatus according to claim 1, wherein
when the section title includes a plurality of words, the relevance calculator, by preferentially using a word having a higher degree of the relevance as calculated, sets the relevance of the word as the degree of relevance of the section title.

9. A structured document search method executed in a structured document management apparatus, the method comprising:
storing a structured document that includes a plurality of section texts each including a section title and a body text;
extracting the section titles from the structured document to create a section title list when the structured document is stored;
calculating degrees of conceptual relevance between the section title and words included in the section text corresponding to the section title for each of the section texts;
searching for the section text that includes the word identical to a search keyword;
selecting the section title having a higher degree of relevance with the word identical to the search keyword more preferentially than the section title having a lower degree of relevance with the word identical to the search keyword; and
displaying the selected section title on a display unit as a presentation section title.

10. A structured document search method executed in a structured document management apparatus, the method comprising:
storing a structured document that includes a plurality of section texts each including a section title and a body text;
extracting the section titles from the structured document to create a section title list when the structured document is stored;
searching for the section text that includes the word identical to a search keyword;
calculating degrees of conceptual relevance between the word identical to the search keyword and the section titles including the word;
selecting the section title having a higher degree of relevance with the search keyword more preferentially than the section title having a lower degree of relevance with the search keyword; and
displaying the selected section title on a display unit as a presentation section title.
